(19) United States
(12) Patent Application Publication
(10) Pub. No.: US 2018/0236668 A1
(43) Pub. Date: Aug. 23, 2018

(54) CARRIER DEVICE

(71) Applicant: Panasonic Intellectual Property Management Co., Lt, Osaka (JP)

(72) Inventors: TAKESHI UEMURA, Osaka (JP); ATSUHITO TERAO, Osaka (JP); KOUMEI FUJITA, Osaka (JP)

(21) Appl. No.: 15/750,531

(22) PCT Filed: Oct. 26, 2016
(86) PCT No.: PCT/JP2016/004701

§ 371 Date: Feb. 6, 2018

Related U.S. Application Data
(60) Provisional application No. 62/246,981, filed on Oct. 27, 2015.

(51) Int. Cl. B25J 13/08; G05D 1/08; B25J 11/00

(52) U.S. Cl. CPC B25J 13/089; B25J 13/087; B25J 11/005; G05D 1/08

(57) ABSTRACT

A carrier device includes a work part having a loading surface configured to have an object placed thereon, a base being movable, a support part supporting the work part movably with respect to the base, a detector provided at one of the work part and the base, and a controller, the detector is configured to detect a gravitational acceleration and a linear acceleration applied thereto. The controller is configured to control the support part so as to tilt the work part and linearly move the work part with respect to the base based on the gravitational acceleration and the linear acceleration. This carrier device prevents the object from falling down on the loading surface even while moving.

### TECHNICAL FIELD

The present invention relates to a carrier device for carrying an object loaded thereon.

### BACKGROUND ART

PTL1 discloses a transfer device having a loading part for placing a transfer object. This transfer device is configured to move the transfer object while the transfer object stops with respect to the loading part by tilting the loading part.

### CITATION LIST

### Patent Literature

PTL1: Japanese Patent Laid-Open Publication No. 2010-225139

### SUMMARY

A carrier device includes a work part having a loading surface configured to have an object placed thereon, a base being movable, a support part supporting the work part movably with respect to the base, a detector provided at one of the work part and the base, and a controller, the detector is configured to detect a gravitational acceleration and a linear acceleration applied thereto. The controller is configured to control the support part so as to tilt the work part and linearly move the work part with respect to the base based on the gravitational acceleration and the linear acceleration.

This carrier device prevents the object from falling down on the loading surface even while moving.

### BRIEF DESCRIPTION OF DRAWINGS

FIG. 1 is a perspective view of a carrier device in accordance with an exemplary embodiment.

FIG. 2 is a top view of the carrier device in accordance with the embodiment.

FIG. 3 is a side view of the carrier device in accordance with the embodiment.

FIG. 4 is a functional block diagram of the carrier device in accordance with the embodiment.

FIG. 5 is a side view of the carrier device moving in accordance with the exemplary embodiment while moving.

### DETAILED DESCRIPTION OF PREFERRED EMBODIMENT

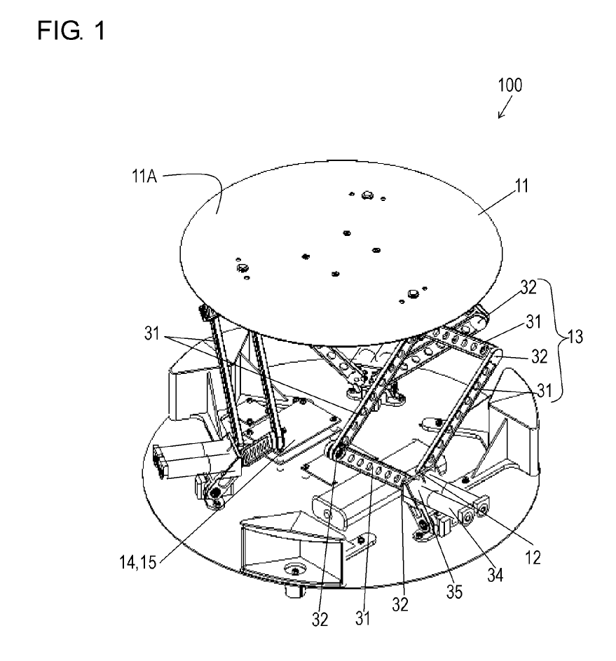

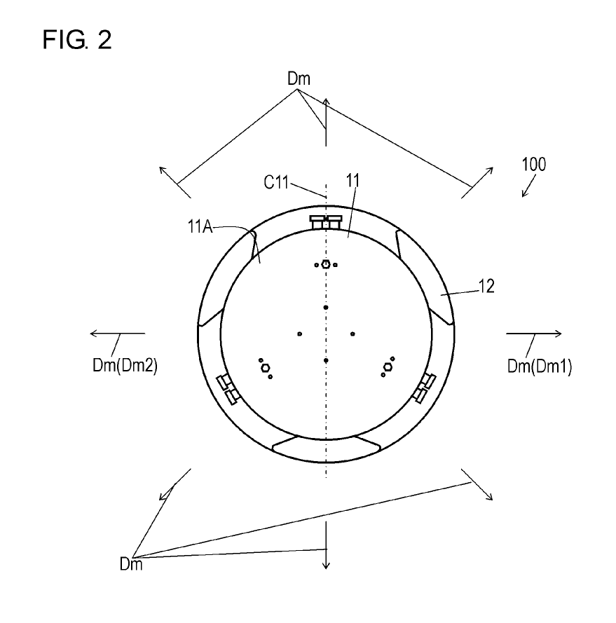

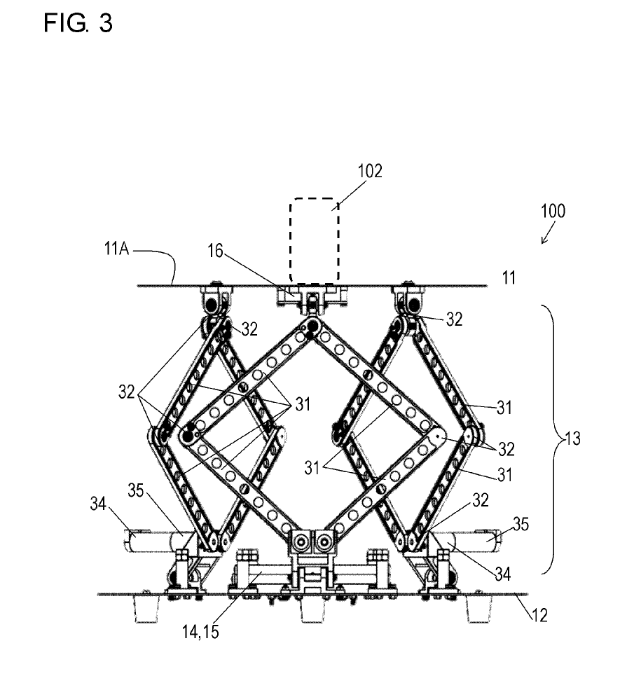

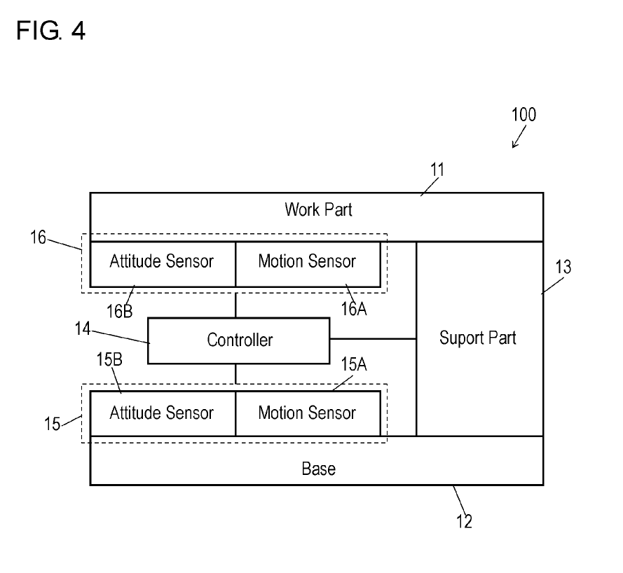

FIG. 1, FIG. 2, and FIG. 3 are a perspective view, top view, and side view of carrier device 100 in an exemplary embodiment, respectively. FIG. 4 is a functional block diagram of carrier device 100. Carrier device 100 includes work part 11 having loading surface 11A configured to have object 102 placed on loading surface 11A, base 12 being movable, support part 13 supporting work part 11 movably with respect to base 12, detector 15 fixed to base 12, detector 16 fixed to work part 11, and controller 14 connected to detectors 15 and 16 and support part 13.

Support part 13 includes arm 31 coupled to work part 11 and base 12, joint 32 allowing arm 31 to deform to fold, encoder 34 configured to detect the state of joint 32, and motor 35 driving joint 32. Controller 14 controls motor 35 by feeding back an output of encoder 34 so as to allow arm 31 to deform to fold. This configuration causes work part 11 to tilt with respect to base 12 by rotating work part 11 by a predetermined angle about predetermined center axis C11 in plural directions Dm along loading surface 11, and to move linearly with respect to base 12 by a predetermined distance in a predetermined direction. Work part 11 can be tilted with respect to base 12 in plural directions Dm along loading surface 11A.

As shown in FIG. 4, detector 15 includes motion sensor 15A and attitude sensor 15B. Motion sensor 15A detects an acceleration applied thereto, and is implemented by an inertial force sensor in accordance with the embodiment. Attitude sensor 15B directly or indirectly detects an attitude with respect to an absolute direction, such as vertical direction D1, and is implemented by a gyro sensor in accordance with the embodiment. Detector 15 has reference direction D15 that serves as a reference for acceleration and attitude to be detected. Since detector 15 is fixed onto base 12, motion sensor 15A detects an acceleration applied to the base. Attitude sensor 15B directly or indirectly detects an attitude of detector 15, i.e., an angle of reference direction D15 with respect to the absolute direction, such as vertical direction D1. Motion sensor 15A may further detect an angular velocity applied to detector 15. Since detector 15 is fixed onto base 12, reference direction D15 is fixed with respect to base 12 and is thus fixed with respect to direction Dm. Detector 15 can detect a direction of linear acceleration AL100 applied due to inertia caused by linear acceleration A1 in direction Dm.

As shown in FIG. 2 and FIG. 3, carrier device 100 can move in various substantially horizontal directions Dm. Controller 14 controls support part 13 so as to rotate work part 11 and linearly move work part 11 with respect to base 12. This configuration allows carrier device 100 to move object 102 on loading surface 11A in various directions Dm without causing object 102 to fall down.

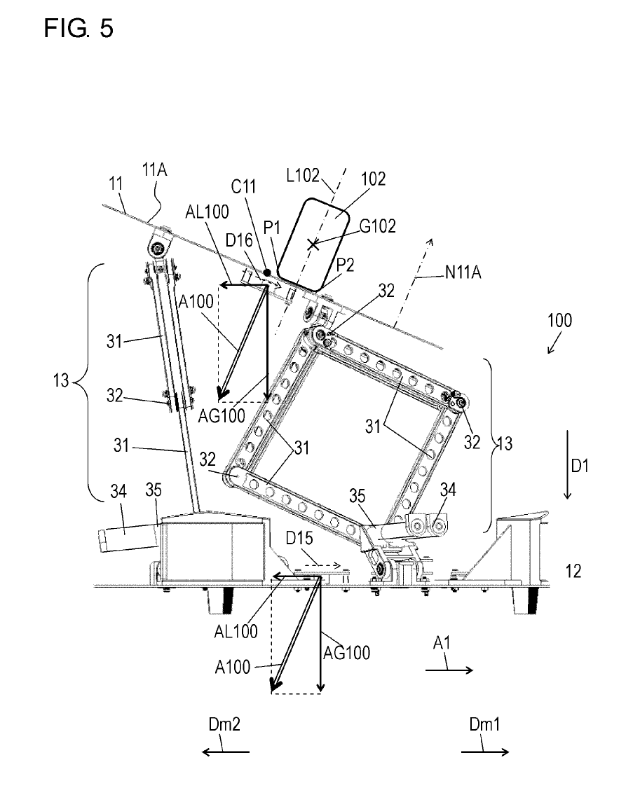

An operation of carrier device 100 will be described below. FIG. 5 is a side view of carrier device 100 moving at acceleration A1 in direction Dm1 out of directions Dm. Linear acceleration AL100 in a direction opposite to acceleration A1 is applied to object 102 due to inertia. Gravitational acceleration AG100 is also applied to object 102. Composite acceleration A100 which is the sum of linear acceleration AL100 and gravitational acceleration AG100 is thus applied to object 102. In carrier device 100, support part 13 tilts loading surface 11A of work part 11 such that normal direction N11A of loading surface 11A of work part 11 tilts in a direction opposite to the direction of linear acceleration AL100 in order to prevent object 102 from falling down on loading surface 11A.

Motion sensor 15A of detector 15 shown in FIG. 4 detects composite acceleration A100 applied to detector 15. Attitude sensor 15B detects a direction of gravitational acceleration AG100 applied to detector 15. Detector 15 divides composite acceleration A100 into linear acceleration AL100 and gravitational acceleration AG100 based on detected composite acceleration A100, the direction of gravitational acceleration AG100, and the direction of linear acceleration AL100.

Controller 14 controls, based on gravitational acceleration AG100 and linear acceleration AL100 detected by detector 15, support part 13 so as to rotate and tilt work part 11 about center axis C11 on loading surface 11A and to move work part 11 in a direction parallel to linear acceleration AL100 with respect to base 12. More specifically, based on gravitational acceleration AG100 and linear acceleration AL100, controller 14 determines an angle by which work part 11 rotates about center axis C11, determines a distance by which work part 11 moves with respect to base 12, and determines a direction in which move work part 11 moves with respect to base 12. Controller 14 controls support part 13 so as to rotate work part 11 about center axis C11 by the determined angle and move work part 11 with respect to base 12 by the determined distance in the determined direction. Controller 14 thus performs a feedforward control on support part 13 based on gravitational acceleration AG100 and linear acceleration AL100.

When linear acceleration AL100 changes, controller 14 controls support part 13 so as to rotate work part 11 about center axis C11 to change a tilt angle of work part 11 with respect to base 12 after starting the linear movement of work part 11 with respect to base 12. More specifically, when linear acceleration AL100 increases, controller 14 controls support part 13 so as to rotate work part 11 about center axis C11 to change the tilt angle with respect to base 12 after starting the linear movement of work part 11 with respect to base 12 at a speed having a component in a direction of linear acceleration AL100. On the other hand, when linear acceleration AL100 decreases, controller 14 controls support part 13 so as to rotate work part 11 about center axis C11 to change the tilt angle with respect to base 12 after starting the linear movement of work part 11 with respect to base 12 at a speed having a component in a direction opposite to linear acceleration AL100. In accordance with the embodiment, when linear acceleration AL100 increases, controller 14 controls support part 13 so as to rotate work part 11 about center axis C11 to change the tilt angle with respect to base 12 after starting the linear movement of work part 11 with respect to base 12 at a speed in a direction of linear acceleration AL100. On the other hand, when linear acceleration AL100 decreases, controller 14 controls support part 13 so as to rotate work part 11 about center axis C11 to change the tilt angle with respect to base 12 after starting the linear movement of work part 11 with respect to base 12 at a speed in a direction opposite to linear acceleration AL100.

When linear acceleration AL100, i.e., acceleration A1, decreases and becomes an acceleration in direction Dm2 opposite to direction Dm1 of acceleration A1, carrier device 100 regards direction Dm2 as direction Dm1, and performs the above operation.

The transfer device disclosed in PTL1 is to move a transfer object while the object stops relatively to a loading part by tilting the loading part. Similarly to this transfer device, falling down of object 102 may be prevented by tilting loading surface 11A of work part 11 at a predetermined angle with respect to base 12 when carrier device 100 moves at constant acceleration A1.

When acceleration A1 changes, object 102 can be prevented from falling down by rotating and tilting work part 11 simultaneously to the change of the acceleration. However, work part 11 can be hardly rotate practically simultaneously to the change of acceleration A1 since work part 11 rotates after detecting the change of acceleration A1. A time gap thus exists between the change of acceleration A1 and the rotation of work part 11. As a result, object 102 may tilt with respect to loading surface 11A and fall down. Accordingly, the transfer device disclosed in PTL1 allows the object to tilt with respect to the loading part and fall down. Still more, when work part 11 is tilted to move upward in a direction opposite to gravitational acceleration AG100, object 102 may further tilt and fall down.

As described above, when linear acceleration AL100 changes, controller 14 of carrier device 100 in accordance with the embodiment controls support part 13 so as to rotate work part 11 about center axis C11 to change the tilt angle pf work part 11 with respect to base 12 after starting the linear movement of work part 11 with respect to base 12. This configuration can reduce linear acceleration AL100 first by the linear movement, and then, tilt work part 11. This operation prevents object 102 from tilting and falling down on loading surface 11A of work part 11 even when acceleration A1 changes.

An advantage of carrier device 100 to object 102 in accordance with the embodiment will be described below. Controller 14 controls support part 13 such that composite acceleration A100 which is the sum of gravitational acceleration AG100 and linear acceleration AL100 becomes substantially perpendicular to loading surface 11A. This configuration prevents object 102 from tilting and falling on loading surface 11A of work part 11. More specifically, object 102 contacts loading surface 11A at least at two points P1 and P2. Controller 14 is configured to control support part 13 such that straight line L102 passing center G102 of gravity of object 102 and extending in a direction of composite acceleration A100 passes between points P1 and P2. This configuration prevents object 102 from tilting and falling down on loading surface 11A of work part 11 even when composite acceleration A100 is not exactly perpendicular to loading surface 11A.

Controller 14 can control support part 13 only based on an output of detector 15 of carrier device 100. In this control, since detector 15 is provided at base 12, controller 14 detects an angle, an acceleration, and an angular velocity accurately and promptly to control support part 13 immediately. However, controller 14 indirectly detects the position and the tilt angle of work part 11 based on an output of encoder 34. Accordingly, an angle, moving distance, and velocity may not necessarily be determined values accurately.

In carrier device 100, controller 14 can control support part 13 only based on an output of detector 16. The operation will be described below.

As shown in FIG. 4 and FIG. 5, detector 16 includes motion sensor 16A and attitude sensor 16B. Motion sensor 16A detects an acceleration applied thereto, and is implemented by an inertial force sensor in accordance with the embodiment. Attitude sensor 16B directly or indirectly detects an attitude with respect to an absolute direction, such as vertical direction D1, and is implemented by a gyro sensor in accordance with the embodiment. Detector 16 has reference direction D16 that serves as a reference for acceleration and attitude to be detected. Since detector 16 is fixed onto work part 11, motion sensor 16A detects an acceleration applied to detector 16, and attitude sensor 16B directly or indirectly detects an attitude, i.e., an angle in reference direction D16, of detector 16 with respect to the absolute direction, such as vertical direction D1. Motion sensor 16A may further detect an angular velocity applied to detector 16. Since detector 16 is fixed onto work part 11, reference direction D16 is fixed with respect to work part 11, and is thus fixed with respect to direction Dm. Accordingly, detector 16 can detect a direction of linear acceleration AL100 applied due to inertia with respect to acceleration A1 in direction Dm.

Motion sensor 16A of detector 16 detects composite acceleration A100 applied to detector 16. Attitude sensor 16B detects a direction of gravitational acceleration AG100 applied to detector 16. Detector 16 divides composite acceleration A100 into linear acceleration AL100 and gravitational acceleration AG100 based on detected composite acceleration A100, the direction of gravitational acceleration AG100, and the direction of linear acceleration AL100.

Controller 14 controls support part 13 in a way such that a direction of composite acceleration A100 detected by detector 16 becomes substantially perpendicular to loading surface 11A fixed in reference direction D16. This makes work part 11 linearly move with respect to base 12, and rotate to tilt. In this way, controller 14 applies feedback control to support part 13, based on composite acceleration A100.

The above operation allows controller 14 to control support part 13 so as to change the tilt angle of work part 11 with respect to base 12 by rotating work part 11 about center axis C11 only based on an output of detector 16, similarly to the case of using an output of detector 15. This prevents object 102 from tilting and falling down on loading surface 11A of work part 11 even when composite acceleration A100 is not exactly perpendicular to loading surface 11A.

In the above operation, detector 16 can directly and accurately detect the tilt angle of work part 11.

In carrier device 100 in accordance with the embodiment, controller 14 controls support part 13 based on outputs of both detectors 15 and 16. The operation will be described below.

As described above, controller 14 performs the feedforward control on support part 13 so as to rotate work part 11 about center axis C11 by the angle determined based on gravitational acceleration AG100 and linear acceleration AL100 detected by detector 15, and move work part 11 by the determined distance in the determined direction. In addition, controller 14 performs the feedback control on support part 13 based on an output of detector 16 so that the tilt angle of work part 11 becomes the determined angle. In other words, controller 14 is configured to perform the feedforward control on support part 13 based on gravitational acceleration AG100 and linear acceleration AL100, and performs the feedback control on support part 13 based on gravitational acceleration AG100 and linear acceleration AL100.

This configuration provides the above advantages obtained by using detectors 15 and 16 independently. Accordingly, work part 11 can be promptly and accurately controlled. Since detector 15 and detector 16 directly detect an acceleration and angle of base 12 and work part 11, controller 14 can control support part 13 in accordance with a common control algorithm regardless of the structure of support part 13. This configuration can increase development efficiency of control algorithm. For example, support part 13 is controllable using a common control algorithm even when support part 13 has a structure other than a pantograph structure including arm 31 and joint 32.

Even when carrier device 10 moves in a changing direction, carrier device 100 is regarded as being moved at an acceleration in a certain direction momentarily. Accordingly, object 102 is prevented from falling down by the above operation in which an accelerating direction is determined as acceleration A1 in direction Dm1 even when carrier device 100 moves while changing its direction.

### REFERENCE MARKS IN DRAWINGS

11 work part
11A loading surface
12 base
13 support part
14 controller
15 detector (first detector)
16 detector (second detector)
31 arm
32 joint
34 encoder
100 carrier device
102 object
A100 composite acceleration
AG100 gravitational acceleration (first gravitational acceleration, second gravitational acceleration)
AL100 linear acceleration (first linear acceleration, second linear acceleration)

1. A carrier device comprising:
a work part having a loading surface configured to have an object placed thereon;
a base being movable;
a support part supporting the work part movably with respect to the base;
a first detector provided at one of the work part and the base, the first detector being configured to detect a first gravitational acceleration and a first linear acceleration applied thereto; and
a controller configured to control, based on the first gravitational acceleration and the first linear acceleration, the support part so as to tilt the work part and linearly move the work part with respect to the base.

2. The carrier device of claim 1, wherein, when the first linear acceleration changes, the controller controls the support part so as to rotate the work part to change a tilt angle of the work part after starting a linear movement of the work part.

3. The carrier device of claim 2, wherein, when the first linear acceleration change, the controller controls the support part so as to rotate the work part to change the tilt angle after starting the linear movement of the work part in a direction parallel to the first linear acceleration.

4. The carrier device of claim 3, wherein, when the first linear acceleration increases, the controller controls the support part so as to rotate the work part to change the tilt angle after starting the linear movement of the work part at a speed having a component in a direction of the first linear acceleration.

5. The carrier device of claim 3, wherein, when the first linear acceleration decreases, the controller controls the support part so as to rotate the work part to change the tilt angle after starting the linear movement of the work part at a speed having a component in a direction opposite to the first linear acceleration.

6. The carrier device of claim 3, wherein, when the first linear acceleration increases, the controller controls the support part so as to rotate the work part to change the tilt angle after starting the linear movement of the work part at a speed in a direction of the first linear acceleration.

7. The carrier device of claim 3, wherein, when the first linear acceleration decreases, the controller controls the support part so as to rotate the work part to change the tilt angle after starting the linear movement of the work part at a speed in a direction opposite to the first linear acceleration.

8. The carrier device of claim 1, further comprising
a second detector provided at the work part, the second detector being configured to detect an acceleration applied thereto,
wherein the one of the work part and the base is the base, and
wherein the controller controls, based on the first gravitational acceleration, the first linear acceleration, and the acceleration detected by the second detector, the support part so as to tilt the work part and linearly move the work part with respect to the base.

9. The carrier device of claim 8,
wherein, based on the acceleration detected by the second detector, the second detector detects a second gravitational acceleration and a second linear acceleration applied to the work part, and
wherein, based on the first gravitational acceleration, the first linear acceleration, the second linear acceleration, and the second gravitational acceleration, the controller controls the support part so as to tilt the work part and linearly move the work part with respect to the base.

10. The carrier device of claim 9, wherein the controller configured to:
perform a feedforward control of the support part based on the first gravitational acceleration and the first linear acceleration, and
perform a feedback control of the support part based on the second gravitational acceleration and the second linear acceleration.

11. The carrier device of claim 1, wherein the controller controls the support part such that a composite acceleration that is a sum of the first gravitational acceleration and the first linear acceleration becomes substantially perpendicular to the loading surface.

12. The carrier device of claim 1,
wherein the object contacts the loading surface at least at two points, and
wherein the controller controls the support part such that a straight line passing through a center of gravity of the object and extending in a direction of a composite acceleration that is a sum of the first gravitational acceleration and the first linear acceleration passes between the two points.

13. The carrier device of claim 1,
wherein the support part includes:
an arm coupled to the work part and the base;
a joint allowing the arm to deform to fold; and
an encoder configured to detect a state of the joint, and
wherein the controller controls the support part based on an output of the encoder and an output of the first detector.

14. The carrier device of claim 6, wherein, when the first linear acceleration decreases, the controller controls the support part so as to rotate the work part to change the tilt angle after starting the linear movement of the work part at a speed in a direction opposite to the first linear acceleration.
